(19) United States
(12) Patent Application Publication
(10) Pub. No.: US 2007/0214432 A1
(43) Pub. Date: Sep. 13, 2007

(54) Quick naming system of graphics with the same property and method thereof

(76) Inventors: Cheng-Hsun Ho, Taipei (TW); Yu-Chuan Chang, Taipei (TW); Yi-Hsin Hsieh, Taipei (TW); Yung-Chien Cheng, Taipei (TW); Chin-Tien Tseng, Taipei (TW)

Correspondence Address: RABIN & Berdo, PC, 1101 14TH STREET, NW, SUITE 500, WASHINGTON, DC, 20005, US

(21) Appl. No.: 11/370,011

(22) Filed: Mar. 8, 2006

(51) Int. Cl. G06F 17/30

(52) U.S. Cl. 715/845; 703/2; 700/7; 707/1

(57) ABSTRACT

A method for quick naming graphics with the same properties comprises the following steps: selecting a plurality of graphics with the same properties from an operation window, then defining an object name and adding auxiliary symbols behind the object name by using the increment rule to generate a plurality of object names containing the sequentially corresponding auxiliary symbols; and marking the object names containing the respective auxiliary symbols on the respective graphics sequentially and correspondingly. Users may repeat the above steps to continuously select another object name, thereby achieving the quick naming of the graphics.

### BACKGROUND OF THE INVENTION

1. Field of Invention

The present invention relates to a quick naming system and a method thereof, and particularly, to a system for quick naming graphics with the same property and a method thereof applied to a Computer Aided Design (CAD) system.

2. Related Art

A common Computer Aided Design (CAD) system is mostly used in engineering, such as architectural design drawing, mechanical design drawing, integrated circuit layout, aeronautical design, interior design, etc. The CAD system may have the following functions. The first is the input function including the input and modification of graphics, texts, and numerals. The input modes include keyboard entry, light pen entry, and digital slide board entry. The second is the drawing function. The third is the function of creating data for parts and products. When a user inputs related data, the system will display the parts and product on the computer monitor in the manner of 2D or 3D, such as a circuit board design, a machine parts assembly design, etc.

The fourth is the analysis and calculation function, through which the CAD system may calculate physical properties, such as area, volume, center of gravity, moment of force, intensity, etc, of the parts and product, and even perform complicated finite element analysis and modeling analysis. The fifth is the analog function, that is to say, the CAD system may test the performances of each product component in various statuses through the analog method for reference of an end product. The sixth is the parts and product data management function, that is to say, the CAD system may perform the functions of registration, retrieval, output, inspection, control, etc., of data. Therefore, the CAD system is indispensable during the computer automatism process in the manufacturing industry.

In point of the input function of the CAD system, it may edit, beautify, and modify the drawn images and texts, and even present marvelous effects through various excellent special effect processing. Creative and professional works can be designed for work reports, enterprise brief reports, business files or Internet homepages.

However, when a user is drawing, a plurality of graphics with the same properties are drawn and then named through the text edit function. Texts or patterns are input for all the graphics one by one when they are marked with the names. After the inputting is finished, the names of all the graphics are checked one by one manually. The above method has the disadvantages as follows. Firstly, when a large number of names are input, it is very likely for the user to input wrong data and waste time because he/she inputs the names manually. Secondly, for a wide variety of graphic names, even if some graphic names are modified or new graphic names are added, repetitions or mistakes are still inevitable.

In view of the above, the mistakes in the graphic names should be eliminated because they lead to a waste of human resource and time.

### SUMMARY OF THE INVENTION

In view of the above problems, the invention provides a system for quick naming graphics with the same properties and a method thereof, thereby substantially solving the problems of the prior art.

In order to achieve the aforementioned object, the system for quick naming graphics with the same properties disclosed by the invention comprises a select interface, a define interface, and an edit interface. First, the select interface is used to select a plurality of graphics with the same properties from an operation window. Then, the define interface is used to define an object name. Finally, the edit interface is used to add auxiliary symbols behind the object name by using a mathematical logic rule and mark the object names containing the respective auxiliary symbols on the respective graphics sequentially and correspondingly.

In order to achieve the aforementioned object, the method for quick naming graphics with the same properties disclosed by the invention comprises the following steps: selecting a plurality of graphics with the same properties from an operation window; defining an object name; adding auxiliary symbols behind the object name by using a mathematical logic rule to generate a plurality of object names containing the auxiliary symbols; and marking the object names containing the respective auxiliary symbols on the respective graphics sequentially and correspondingly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a system for quick naming graphics with the same properties disclosed according to the invention.

FIG. 2 is an embodiment disclosed according to the invention.

FIG. 3 is a method for quick naming graphics with the same properties disclosed according to the invention.

### DETAILED DESCRIPTION OF THE INVENTION

The system for quick naming graphics with the same properties and the method thereof disclosed by the invention may avoid waste of human resource and reduce unnecessary mistakes about graphic naming.

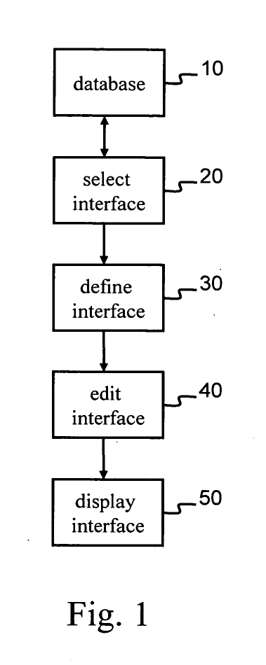

Referring to FIG. 1, it is a block diagram of a system for quick naming graphics with the same properties disclosed according to the invention. The quick naming system comprises a database 10, a select interface 20, a define interface 30, an edit interface 40, and a display interface 50. The detailed operation and connecting blocks are illustrated below.

Firstly, at least one object class and at least one object name in the object class are stored in the database 10. For example, the object class is a signal line and the object name is input signal line 1, etc., wherein the object class can be selected from the group consisting of a text, a graphic, and a letter of English.

Then, a plurality of graphics with the same properties are selected from an operation window through the select interface 20. For example, a plurality of graphics representing the inputs are selected from the operation window displayed on the computer monitor. An object name, for example, input signal line 1, to be used to name the graphics is defined through the define interface 30, wherein the object name can be selected from the group consisting of a text, a graphic, and a letter of English.

Subsequently, auxiliary symbols are added behind the object name by using a mathematical logic rule through the edit interface 40, thereby generating a plurality of object names containing sequentially corresponding auxiliary symbols, such as input signal line 1_1, input signal line 1_2, input signal line 1_3, etc. Then, the object names containing the respective auxiliary symbols are marked on the respective graphics sequentially and correspondingly, wherein the auxiliary symbols are selected from the group consisting of a text, a graphic, and a letter of English. The mathematical logic rule includes one of an accumulation rule and a multiplication rule.

Finally, the respective graphics and the object names containing the respective auxiliary symbols marked on the respective graphics are displayed on the display interface 50. Additionally, when a single graphic is selected from the operation window through the select interface 20, the object name is directly marked on the selected graphic through the edit interface 40.

Moreover, when an object class or an object name is defined through the define interface 30, object classes or object names may also be added through an adding interface, for example, an adding icon, and the added object classes and the added object names are stored in the database.

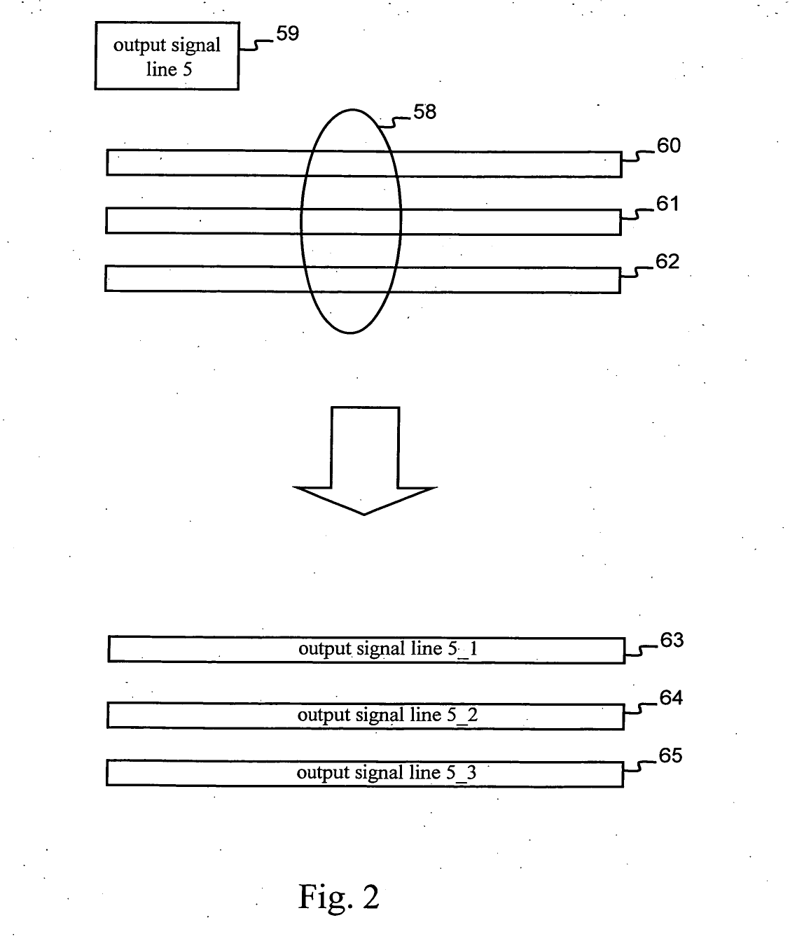

Referring to FIG. 2, it is an embodiment disclosed according to the invention. A user selects 58 three signal line graphics 60, 61, 62 with the same properties from the operation window through the select interface 20. Then, an object name 59, i.e., output signal line 5, to be used to name the selected signal line graphic is defined through the define interface 30. Subsequently, auxiliary symbols are added behind the object name by using a mathematical logic rule through the edit interface 40, thereby generating a plurality of object names containing sequentially corresponding auxiliary symbols, that is to say, the auxiliary symbols are numbered through the increment rule, such as output signal line 5_1, output signal line 5_2, and output signal line 5_3. Finally, a plurality of object names containing the numbers are marked on the three signal line graphics sequentially and correspondingly, thereby quickly naming a plurality of signal line graphics, i.e., the signal line graphics 63, 64 and 65. The mathematical logic rule is unnecessarily to be the increment rule, and the multiplication rule may also be used.

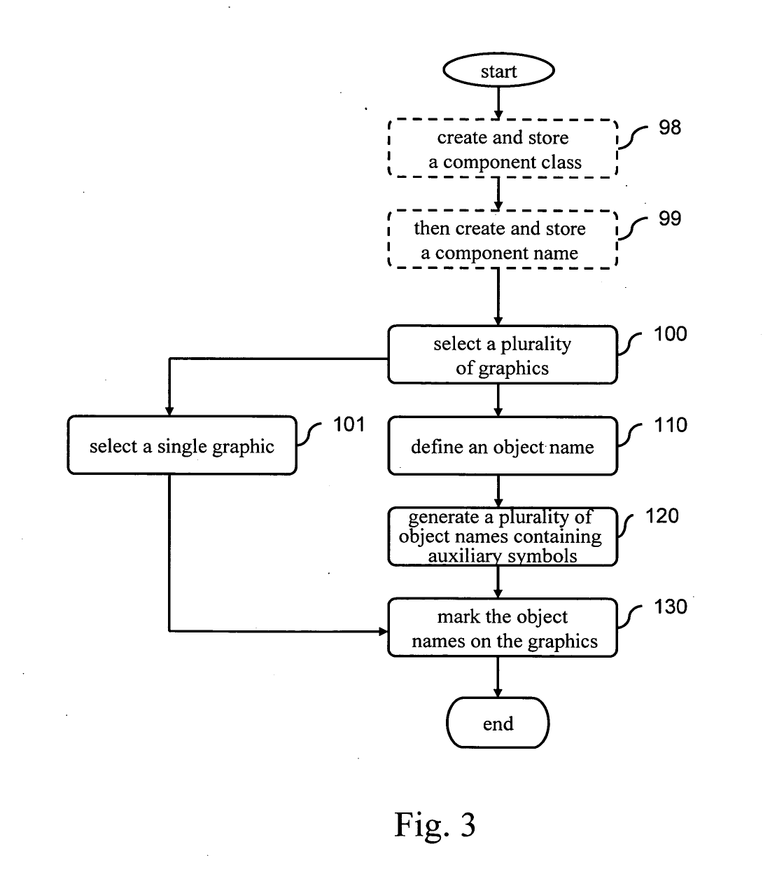

Referring to FIG. 3, it is a method for quick naming graphics with the same properties disclosed according to the invention. The method comprises the steps as follows. Firstly, at least one object class is created and stored in the database (Step 98). For example, the object class is a signal line, wherein the object class is selected from the group consisting of a text, a graphic, and a letter of English. At least one object name is created and stored according to the object class (Step 99). For example, the object name is input signal line 1. Then a plurality of graphics with the same properties, such as a plurality of graphics representing the inputs, are selected from the operation window (Step 100), and then the object name, such as input signal line 1, is defined (Step 110), wherein the object name is selected from the group consisting of a text, a graphic, and a letter of English.

Then, auxiliary symbols are added behind the object name by a mathematical logic rule, thereby generating a plurality of object names containing the sequentially corresponding auxiliary symbols (Step 120), such as input signal line 1_1, input signal line 1_2, input signal line 1_3, etc. The auxiliary symbols are selected from the group consisting of a text, a graphic, and a letter of English. The mathematical logic rule includes one of an accumulation rule and a multiplication rule.

Finally, the object names containing the respective auxiliary symbols are marked on the respective graphics sequentially and correspondingly (Step 130), thereby finishing the quick naming process. Additionally, in the step of selecting a plurality of graphics with the same properties from the operation window (Step 100), if a single graphic is selected from the operation window (Step 101), the object name is directly marked on the graphic.

Furthermore, an adding command may be executed when the object class or object name is defined, for generating a new object class or object name and storing the new object class or object name in the database.

In summary, the system for quick naming graphics with the same properties and the method thereof disclosed by the invention not only save the human resource and operating time of drawing, but also reduce unnecessary mistakes about graphic naming.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for quick naming graphics with the same properties, comprising:
selecting a plurality of graphics with the same properties from an operation window;
defining an object name;
adding an auxiliary symbol behind the object name by using a mathematical logic rule, thereby generating a plurality of object names containing the sequentially corresponding auxiliary symbols; and
marking the object names containing the respective auxiliary symbols on the respective graphics sequentially and correspondingly.

2. The quick naming method of claim 1, wherein the step of selecting a plurality of graphics with the same properties from an operation window includes:
creating and storing at least one object class in a database; and
creating and storing at least one object name according to the object name.

3. The quick naming method of claim 2, wherein the object class is selected from the group consisting of a text, a graphic and a letter of English.

4. The quick naming method of claim 1, wherein the object name is selected from the group consisting of a text, a graphic and a letter of English.

5. The quick naming method of claim 1, wherein the auxiliary symbol is selected from the group consisting of a text, a graphic and a letter of English.

6. The quick naming method of claim 1, wherein the mathematical logic rule includes one of an accumulation rule and a multiplication rule.

7. The quick naming method of claim 1, wherein in the step of selecting a plurality of graphics with the same properties from an operation window, when a single graphic is selected from the operation window, the step of marking the object name on the graphic is performed.

8. A system for quick naming graphics with the same properties, comprising:
a select interface used to select a plurality of graphics with the same properties from an operation window;
a define interface used to define an object name; and
an edit interface used to add an auxiliary symbol behind the object name by using a mathematical logic rule and mark the object names containing the respective auxiliary symbols on the respective graphics sequentially and correspondingly.

9. The quick naming system of claim 8, further comprising:
a database storing an object class and the object name in the object class; and
a display interface displaying the respective graphics and the object names containing the respective auxiliary symbols marked on the respective graphics.

10. The quick naming system of claim 9, wherein the object class is selected from the group consisting of a text, a graphic and a letter of English.

11. The quick naming system of claim 8, wherein the object name is selected from the group consisting of a text, a graphic and a letter of English.

12. The quick naming system of claim 8, wherein the auxiliary symbol is selected from the group consisting of a text, a graphic and a letter of English.

13. The quick naming system of claim 8, wherein the mathematical logic rule includes one of an accumulation rule and a multiplication rule.

14. The quick naming system of claim 8, wherein when a single graphic is selected from the operation window through the select interface, the object name is directly marked on the graphic through the edit interface.
